(19) United States
(12) Patent Application Publication
(10) Pub. No.: US 2005/0076101 A1
(43) Pub. Date: Apr. 7, 2005

(54) Apparatus for downloading control frequency code data

(76) Inventor: Hyoung-Rack Choi, Kyunggi-do (KR)

Correspondence Address: COLEMAN SUDOL SAPONE, P.C., 714 COLORADO AVENUE, BRIDGE PORT, CT, 06605-1601, US

(21) Appl. No.: 10/494,735

(22) PCT Filed: Nov. 20, 2002
(86) PCT No.: PCT/KR02/02166

(30) Foreign Application Priority Data
Nov. 22, 2001 (KR) 2001/72949

(51) Int. Cl. G06F 9/44; G06F 9/445; G06F 15/16; G06F 15/177

(52) U.S. Cl. 709/220; 709/222; 709/219; 717/172; 717/176; 717/173; 717/178

(57) ABSTRACT

An apparatus for downloading control frequency code data, a multi-purpose remote controller, and a mobile communication terminal used as the same, for downloading control frequency code data with respect to each of electronic equipment sets, loaded in a server, and automatically setting each to perform a remote control function. An apparatus for downloading control frequency code data further comprising a server in which control frequency code data with respect to each of the electronic equipment sets is loaded, a communication terminal for downloading the control frequency code data with respect to each of the electronic equipment sets loaded in the server through the Internet, and a multi-purpose remote controller for executing a predetermined program to automatically set the frequency code data with respect to each electronic equipment set, provided by the communication terminal, thereby performing a remote control function corresponding to the control frequency code.

### TECHNICAL FIELD

The present invention relates to an apparatus for downloading control frequency code data, a multi-purpose remote controller, and a mobile communication terminal used as the same. Specifically, the invention relates to an apparatus for downloading control frequency code data, a multi-purpose remote controller, and a mobile communication terminal used as the same, for downloading control frequency code data for each of electronic equipment sets, loaded in a server, and automatically setting it to perform a remote control function.

### BACKGROUND ART

In general, a remote controller is a device that remotely controls various functions of an electronic equipment set such as a television set, a video tape recorder, an audio set, an air conditioner, a wire broadcast converter, a satellite broadcast converter, an electric fan and the like through radio transmission of a control frequency.

The electronic equipment sets respectively have their own remote controllers because they use different frequency bands in order to prevent other equipment sets from erroneous operation. In case that a plurality of electronic equipment sets are used, accordingly, various complicated problems are generated in selection of a desired function because a desired function is performed by the remote controller corresponding to each electronic equipment set in order to remotely control each equipment set.

Accordingly, in order to remotely control a plurality of electronic equipment sets with one remote controller, there has been developed a multi-purpose remote controller having control frequency codes respectively set for the electronic equipment set manufacturers and the electronic equipment sets produced by the manufacturers.

A general search method is used for setting a control frequency between the multi-purpose remote controller and electronic equipment produced by a manufacturer. Specifically, in order to search and set a control frequency between any electronic equipment produced by any set maker and the multi-purpose remote controller, the control frequency codes set to the multi-purpose remote controller should be repeatedly extracted until the one matched with the electronic equipment to be used is detected.

If about 300 control frequency codes are set to the multi-purpose remote controller, a user must perform frequency search operations at least 300 times in order to set the remote control frequency code suitable for any electronic equipment set. For example, in order to set a control frequency between the multi-purpose remote controller and a television set manufactured by Samsung Electronic Co. of Korea, numerous control frequency codes set to the multi-purpose remote controller are sequentially extracted through repeated operations until the one matched with the television set is found.

As described above, the conventional multi-purpose remote controller should carry out repeated search for control frequency code in order to set a control frequency suitable for a specific electronic equipment set so that a long period of time is required for the operation. In addition, its user should have the patience to carry out the repeated operations and the control frequency code search operation has a rare chance of success. Furthermore, old people or children who are not well acquainted with the functions of the multi-purpose remote controller cannot select a desired function, deteriorating reliability in utilization of the multi-purse remote controller.

FIG. 1 is a block diagram of a conventional multi-purpose remote controller developed for improving the aforementioned problems. As shown in FIG. 1, the conventional multi-purpose remote controller includes a keypad 10 that is composed of a matrix of X and Y axes intersecting each other and outputs a select signal according to voltage drop when an arbitrary intersection contact point is selected, a controller 20 having programs set thereto and analyzing a signal outputted from the keypad 10 to generate a predetermined corresponding control signal, and an oscillator 30 for applying a predetermined clock signal to the controller 20 to maintain a stable operation of the controller. The multi-purpose remote controller further includes a power supply 50 composed of a first condenser C1 that is an electrolytic condenser and a second condenser C2 that is a ceramic condenser to maintain back-up power for a specific period of time when a battery BA that is a power source is completely discharged and stably process voltage and current of the battery to supply them to each load, an infrared frequency transmitter 40 for generating and transmitting a predetermined frequency band according to the signal outputted from the controller 20, and an indicator 60 that is turned on when a button of the keypad 10 is selected and the controller 20 generates a frequency to indicate the operation state to a user.

The keypad 10 includes ten keys 0-9, a power select key, up/down keys, volume up/down keys, a set key, a sound reduction key, a previous key return key, a macro key for controlling power of the entire electronic equipment, keys for selecting various electronic equipment sets and predetermined function keys.

The controller 20 has ID code data of each of set makers producing electronic equipment sets, shown in the following table 1, set to the inner memory thereof. In addition, frequency codes controlling the electronic equipment sets produced by the makers are grouped with the maker IDs by the kinds of the electronic equipment sets and stored in the inner memory of the controller 20.

The infrared transmitter 40 includes a resistor R2 for adjusting the intensity of the signal outputted from the controller 20, a transistor TR switched according to a signal applied through the resistor R2, and an LED 1 that is connected to the collector of the transistor TR to emit lights according to the switching operation of the transistor TR.

TABLE 1

| Set maker | Maker ID | TV | VCR | CATV/SAT |
|---|---|---|---|---|
| Haitai | 2130 | 321 | **** | **** |
| Elec. | | | | |
| Samsung | 2131 | 01031, 01121, | 01442, 02002, | 01113, 01323, |
| Elec. | | 02421, 02031, | 03402, 00232, | 01413, 02233, |
| | | 12111 | 01422 | 03103 |
| LG Elec. | 2211 | 01331, 02231, | 00402, 01342, | 00333, 00433, |
| | | 03031, 10331 | 02142 | 01443, 02023 |
| Daewoo | 2142 | 10221, 10321, | 00242, 01012, | 00213, 00223 |
| Elec. | | 11131, 12231 | 02312, 02332, | |
| | | | 024422 | |
| Hitachi | 2133 | 00431, 01321, | 02302, 02322 | 01321, 04231 |
| | | 02231, 03311, | | |
| | | 04021 | | |
| Sony | 2122 | 01231, 01431, | 00202, 01442, | 01423, 02003, |
| | | 11301 | 03232, 03302 | 02043, 02103 |
| Sharp | 2240 | 04011, 04341, | 04102, 01142, | 02302, 02304, |
| | | 11101, 12441, | 04243, 01342 | 02315, 02343 |
| | | 01431 | | |

However, as shown in Table 1, the conventional multi-purpose remote controller is manufactured having a memory storing a large quantity of data and sold to users because its manufacturer does not know which equipment sets belong to users, resulting in increase in its price. Moreover, because a vast amount of data is stored in the multi-purpose remote controller, it is difficult to set code data with the reference to its manual. Even after the code data is set, data is erased when the battery is replaced with a new one or detached from the remote controller so that it is inconvenient for users to set the code data again.

### DISCLOSURE OF INVENTION

Accordingly, an object of the present invention is to provide an apparatus for downloading control frequency code data, a multi-purpose remote controller, and a mobile communication terminal used as the same, for downloading control frequency code data for each of electronic equipment sets, loaded in a server, and automatically setting it to perform a remote control function.

To accomplish the object of the present invention, there is provided an apparatus for downloading control frequency code data, comprising a server in which control frequency code data for each of electronic equipment sets is loaded; a communication terminal for downloading the control frequency code data for each electronic equipment set loaded in the server through the Internet; and a multi-purpose remote controller for executing a predetermined program to automatically set the frequency code data for each electronic equipment set, provided by the communication terminal, thereby performing a remote control function corresponding to the control frequency code.

To accomplish the object of the present invention, there is also provided a multi-purpose remote controller, comprising a keypad that is composed of a matrix of X and Y axes intersecting each other and outputs a select signal according to voltage drop when an arbitrary intersection contact point is selected; a controller for downloading a control frequency code with respect to each of electronic equipment sets, provided by a predetermined communication terminal, executing a predetermined program to automatically set the downloaded control frequency code data, and analyzing a signal outputted from the keypad to generate a predetermined corresponding control signal; and a data memory for storing the downloaded control frequency code for each electronic equipment set.

To accomplish the object of the present invention, there is provided an apparatus for downloading control frequency code data, comprising a server in which control frequency code data for each of electronic equipment sets is loaded; and a mobile communication terminal used as a multi-purpose remote controller, for downloading the control frequency code data for each electronic equipment set loaded in the server through the Internet and automatically setting it, to perform a remote control function corresponding to the control frequency code.

To accomplish the object of the present invention, there is also provided a mobile communication terminal used as a multi-purpose remote controller, comprising a keypad including a plurality of function keys and a multi-purpose remote control mode key; a transmission/reception separation unit for providing control frequency code data for each electronic equipment and general mobile communication data, received through an antenna, and for transmitting a remote control function signal provided thereto through the antenna; a receiver for frequency-converting and demodulating the control frequency code data for each electronic equipment set, provided by the transmission/reception separation unit; a controller for analyzing a signal outputted from the keypad to generate a predetermined control signal for automatically setting the control frequency code data for each electronic equipment, provided by the receiver, to perform a multi-purpose remote control function; and a memory for storing the control frequency code data provided by the controller.

### BRIEF DESCRIPTION OF THE DRAWINGS

Further objects and advantages of the invention can be more fully understood from the following detailed description taken in conjunction with the accompanying drawings, in which:

FIG. 1 is a block diagram of a conventional multi-purpose remote controller;

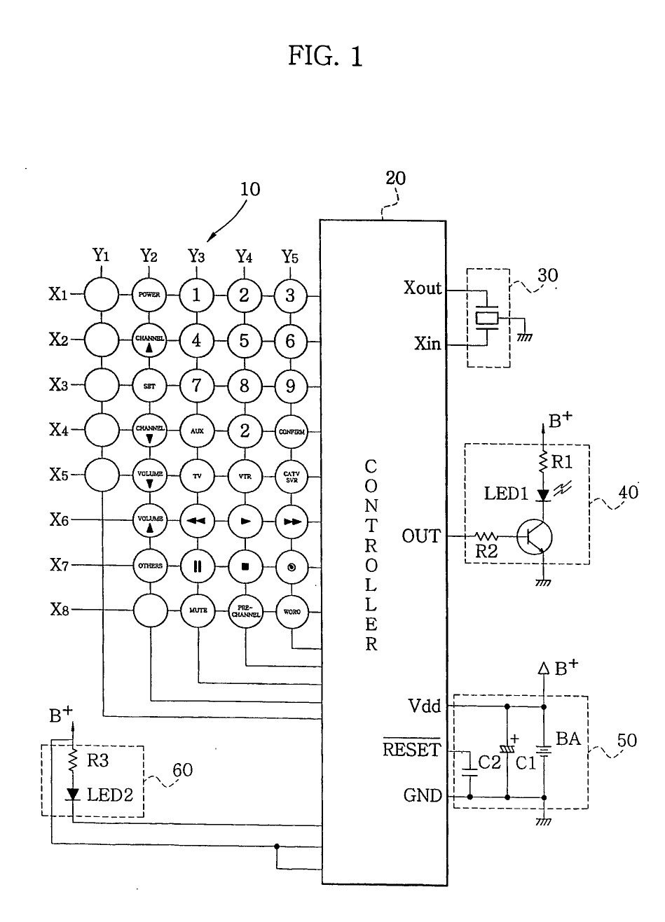

FIG. 2 is a block diagram of an apparatus for downloading control frequency code data according to an embodiment of the present invention;

FIG. 3 is a circuit diagram of the multi-purpose remote controller of FIG. 2;

FIG. 4 shows the connection of the multi-purpose remote controller of FIG. 2 and a personal computer that is a communication terminal;

FIG. 5 shows the connection of the multi-purpose remote controller of FIG. 2 and a mobile communication terminal that is a communication terminal through a predetermined data line;

FIG. 6 is a block diagram of an apparatus for downloading control frequency code data according to another embodiment of the present invention; and

FIG. 7 is a block diagram of a mobile communication terminal used as the multi-purpose remote controller.

### BEST MODE FOR CARRYING OUT THE INVENTION

The present invention will now be described in detail in connection with preferred embodiments with reference to the accompanying drawings.

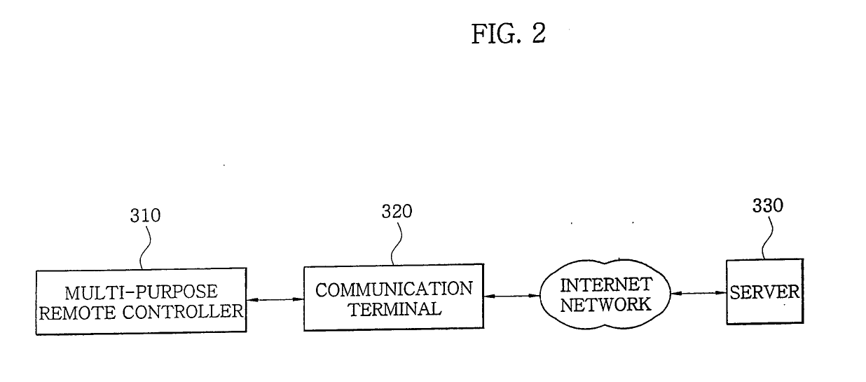

FIG. 2 is a block diagram of an apparatus for downloading control frequency code data according to an embodiment of the present invention.

Referring to FIG. 2, the apparatus for downloading control frequency code data according to an embodiment of the present invention includes a server 330 in which control frequency code data for each of electronic equipment sets is loaded, a communication terminal 320 for downloading the control frequency code data for each electronic equipment set loaded in the server 330, through the Internet to provide it to a multi-purpose remote controller 310, and the multi-purpose remote controller 310 for downloading the control frequency code data for each electronic equipment set, provided by the communication terminal 320, and automatically setting it to perform a remote control function matched with the control frequency code data.

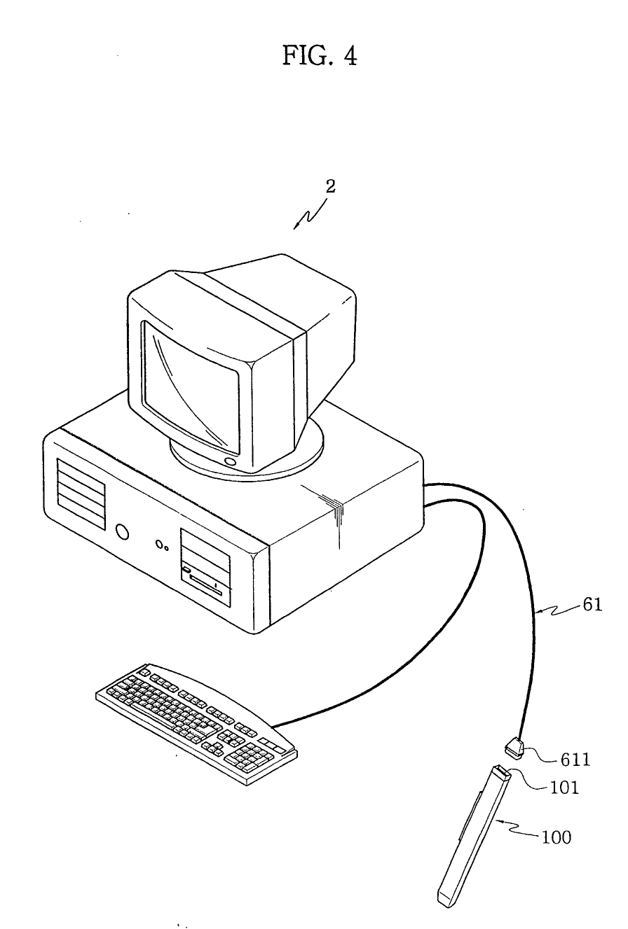

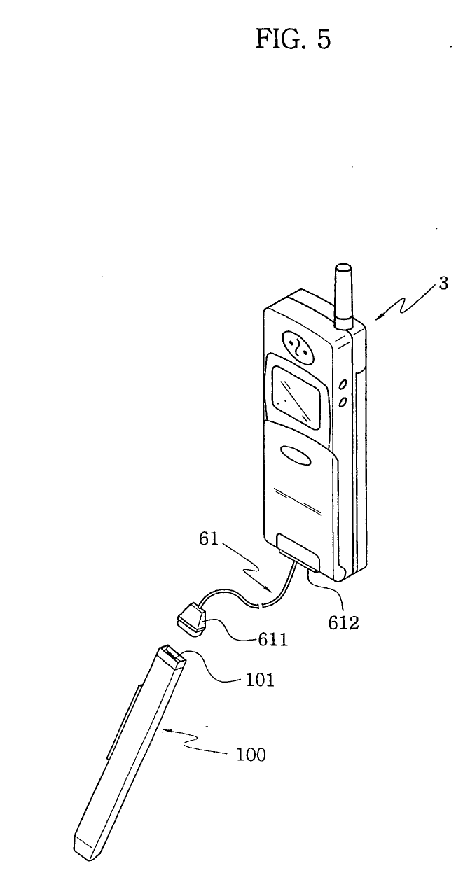

The communication terminal 320 uses a personal computer 2 as shown in FIG. 4 or a mobile communication terminal 3 as shown in FIG. 5.

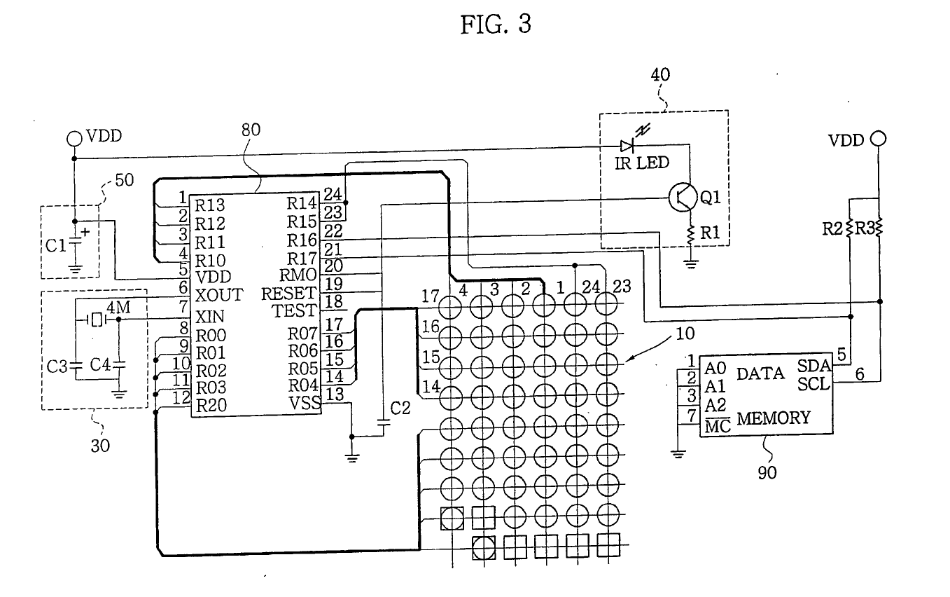

FIG. 3 is a circuit diagram of the multi-purpose remote controller of FIG. 2. Referring to FIG. 3, the multi-purpose remote controller of the invention includes a keypad 10 that is composed of a matrix of X and Y axes intersecting each other and outputs a select signal according to voltage drop when an arbitrary intersection contact point is selected, a controller 80 for downloading the control frequency code data for each electronic equipment set, provided by the communication terminal 320, and executing a predetermined program to automatically set the downloaded control frequency code data in the remote controller and for analyzing a signal outputted from the keypad 10 to generate a predetermined control signal corresponding to the signal, a data memory 90 for storing the downloaded control frequency code data, an oscillator 30 for applying a predetermined clock signal to the controller 80 to maintain a stable operation of the controller, a power supply 50 that is composed of an electrolytic condenser C1, maintains back-up power for a specific period of time when a battery that is a power supply source is completely discharged, and stably processes voltage and current of the battery to supply them to each load, a frequency transmitter 40 for generating a frequency of a predetermined band according to the signal outputted from the controller 80 and transmitting it.

The data memory 90 is composed of an EEPROM (Electrically Erasable and Programmable ROM).

FIG. 4 shows the connection of the multi-purpose remote controller of FIG. 2 and a personal computer that is a communication terminal. As shown in FIG. 4, the multi-purpose remote controller 100 according to the present invention is connected with the personal computer 2 through a predetermined data line 61. The data line 61 includes a connector (not shown) for being connected with a serial port of the personal computer 2 at one end thereof and a connector 661 for connecting the data line 61 with the multi-purpose remote controller 100 at the other end thereof. The multi-purpose remote controller 100 has a connection port 101 electrically connected with the connector 611 of the data line 61.

While it has been described that the communication terminal is the personal computer in FIG. 4, a mobile communication terminal such as personal mobile communication terminal can be used as the communication terminal.

Specifically, a user can use the Internet through his mobile communication terminal such as a cellular phone with the recent development of WAP (Wireless Application Protocol) technology. This mobile communication terminal includes a web browser for accessing the Internet inside so that the user can access the Internet by operating the web browser.

FIG. 5 shows the connection of the multi-purpose remote controller of FIG. 2 and the mobile communication terminal that is a communication terminal through a predetermined data line. Referring to FIG. 5, the connector 611 formed at one end of the data line 61 is connected with the connection port 101 of the multi-purpose remote controller 100 and a connector 612 formed at the other end of the data line 61 is connected with a data input/output port of the mobile communication terminal 3. The web browser set in the mobile communication terminal 3 is executed to download the control frequency code for each electronic equipment set, loaded in the server 330 shown in FIG. 2, through The Internet to provide it to the multi-purpose remote controller.

The operation of the multi-purpose remote controller according to a preferred embodiment of the present invention is explained below in detail.

The server 330 has control frequency code data with respect to each of electronic equipment sets, loaded therein. A user connects his multi-purpose remote controller 100 with his personal computer 2 or mobile communication terminal 3 that is the communication terminal 320 in order to download control frequency code data he wants using the personal computer 2 or mobile communication terminal 3. Then, the user executes the web browser loaded in the personal computer 2 or mobile communication terminal 3 to connect with the server 330, thereby selecting and downloading the control frequency code data he wants.

If the user does not know the control frequency code data required for operating his electronic equipment through the multi-purpose remote controller, the user inquires it of the operator of the server 330 through E-mail. Then, the server operator designates the control frequency code data matched with the electronic equipment of the user to answer the user. Accordingly, the user can select the control frequency code data according to the answer from the server operator. Otherwise, the user can select the control frequency code data matched with his electronic equipment through an agency that made a contact with the server operator.

The control frequency code data selected by the user is downloaded to the personal computer 2 or mobile communication terminal 3 through the Internet, and then provided to the controller 80 of the multi-purpose remote controller 100. The controller 80 receives the control frequency code data provided by the personal computer 2 or mobile communication terminal 3 and executes a program that automatically sets control frequency codes for electronic equipment sets, thereby automatically setting the received control frequency code data. In addition, the controller 80 stores the control frequency code data in the data memory 90.

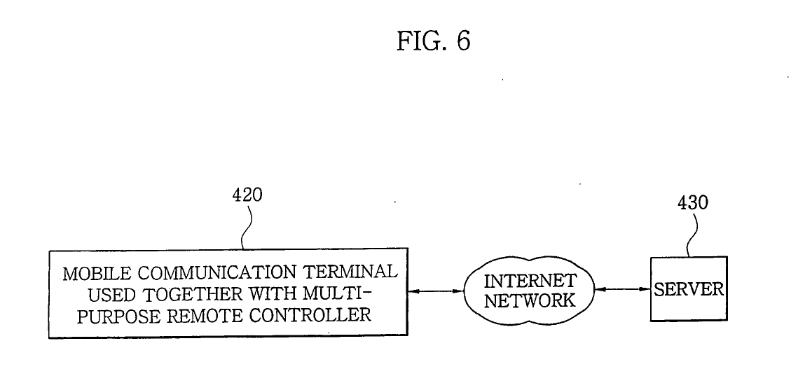

FIG. 6 is a block diagram of an apparatus for downloading control frequency code data according to another embodiment of the present invention.

As shown in FIG. 6, the apparatus for downloading control frequency code data according to another embodiment of the present invention includes a server 430 having control frequency code data for each electronic equipment set loaded therein, and a mobile communication terminal 420 used as the multi-purpose remote controller for downloading the control frequency code data loaded in the server 430 and automatically setting it to perform a remote control function corresponding to the control frequency code.

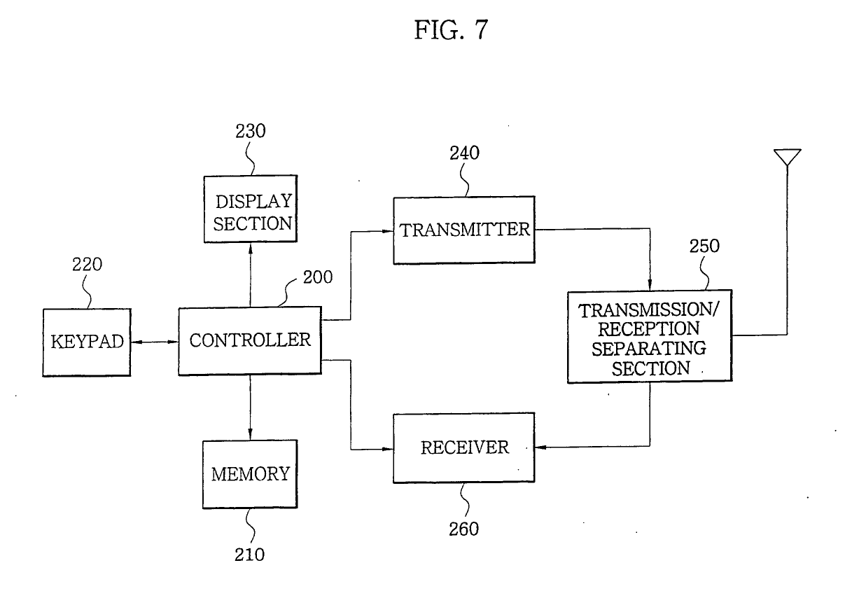

FIG. 7 is a block diagram of the mobile communication terminal used as the multi-purpose remote controller.

As shown in FIG. 7, the mobile communication terminal includes a keypad 220 having a plurality of function keys and a multi-purpose remote control mode key, a transmission/reception separation unit 250 for providing a receiver 260 with control frequency code data for each electronic equipment set and general mobile communication data, received through an antenna, and for transmitting a remote control function signal and general mobile communication data supplied from a transmitter 240 through the antenna, the receiver 260 frequency-converting and demodulating the control frequency code data and general mobile communication data provided by the transmission/reception separation unit 250, a controller 200 for automatically setting the control frequency code data with respect to each electronic equipment set, provided by the receiver 260, executing a function of the general mobile communication terminal according to the general mobile communication data provided by the receiver 260, and analyzing a signal outputted from the keypad 220 to generate predetermined control signals for performing the functions of the multi-purpose remote controller and mobile communication terminal, a memory 210 for storing the control frequency code data provided by the controller 200 and a plurality of control programs of the mobile communication terminal, and a display 230 for displaying a message according to the operation state of the terminal under the control of the controller 200.

The operation of the mobile communication terminal used as the multi-purpose remote controller according to another embodiment of the invention is explained below in detail.

When a user inputs the multi-purpose remote control function key of the keypad 220 in order to use the mobile communication terminal as the multi-purpose remote controller, the controller 200 recognizes the inputted multi-purpose remote control function key to carry out a multi-purpose remote control mode. That is, the controller 200 executes a web browser program stored in the memory 210 to connect with the server 430 in which the control frequency code data for each electronic equipment set is loaded.

Accordingly, the user selects control frequency code data suitable for his electronic equipment from the control frequency code data loaded in the server 430. The control frequency code data selected by the user is provided to the receiver 260 through the transmission/reception separation unit 250.

The receiver 260 frequency-converts and demodulates the received control frequency code data and provides it to the controller 200. The controller 200 receives the control frequency code data from the receiver 260 and executes the program that automatically sets control frequency codes of electronic equipment sets, thereby automatically setting the received control frequency code data. In addition, the controller 200 stores the received control frequency code data in the data memory 210.

### INDUSTRIAL APPLICABILITY

As described above, the present invention downloads a control frequency code with respect to each of electronic equipment sets, through the Internet, and automatically sets it to perform the remote control function. The present invention has the following advantages.

Firstly, a user can select a desired data code among a large amount of data loaded on the Internet to use the multi-purpose remote controller so that it is convenient for the user to use the remote controller. In addition, a small amount of data capacity increases price competitiveness.

Secondly, a low-priced multi-purpose remote controller uses 7 keys only for a TV, a middle-grade multi-purpose remote controller employs 32 keys for both of TV and VCR, and a high-grade one uses 48 keys for TV, VCR, CATV and AUX. Thus, a variety of remote controller models by functions provide users with the wide range of choice so that it is convenient for the users to use the remote controller he wants.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An apparatus for downloading control frequency code data, comprising:
a server in which control frequency code data for each of electronic equipment sets is loaded;
a communication terminal for downloading the control frequency code data for each electronic equipment set loaded in the server through the Internet; and
a multi-purpose remote controller for executing a predetermined program to automatically set the frequency code data for each electronic equipment set, provided by the communication terminal, thereby performing a remote control function corresponding to the control frequency code.

2. The apparatus as claimed in claim 1, wherein the multi-purpose remote controller comprises:
a keypad that is composed of a matrix of X and Y axes intersecting each other and outputs a select signal according to voltage drop when an arbitrary intersection contact point is selected;
a controller for downloading the control frequency code data for each electronic equipment set, provided by the communication terminal, executing a predetermined program to automatically set the downloaded control frequency code data, and analyzing a signal outputted from the keypad to generate a predetermined corresponding control signal; and
a data memory for storing the control frequency code data downloaded to the controller.

3. The apparatus as claimed in claim 2, wherein the data memory is composed of an EEPROM (Electrically Erasable and Programmable ROM).

4. The apparatus as claimed in claim 1, wherein the communication terminal is a personal computer or a mobile communication terminal.

5. The apparatus as claimed in claim 4, wherein the multi-purpose remote controller is connected with the personal computer through a predetermined data line.

6. The apparatus as claimed in claim 5, wherein the data line has a connector for being connected with a serial port of the personal computer at one end thereof, the data line having a connector for connecting the data line with the multi-purpose remote controller at the other end thereof.

7. The apparatus as claimed in claim 4, wherein the multi-purpose remote controller includes a connection port electrically connected with the connector of the data line.

8. The apparatus as claimed in claim 4, wherein the connector of the data line, set at one end thereof, is connected with the connection port of the multi-purpose remote controller and the connector of the data line, set at the other end thereof, is connected with a data input/output port of a mobile communication terminal.

9. A multi-purpose remote controller, comprising:
a keypad that is composed of a matrix of X and Y axes intersecting each other and outputs a select signal according to voltage drop when an arbitrary intersection contact point is selected;
a controller for downloading a control frequency code with respect to each of electronic equipment sets, provided by a predetermined communication terminal, executing a predetermined program to automatically set the downloaded control frequency code data, and analyzing a signal outputted from the keypad to generate a predetermined corresponding control signal; and
a data memory for storing the downloaded control frequency code for each electronic equipment set.

10. The multi-purpose remote controller as claimed in claim 9, further comprising a connection port that is electrically connected with a data line of the predetermined communication terminal.

11. The multi-purpose remote controller as claimed in claim 10, wherein the communication terminal is a personal computer or a mobile communication terminal.

12. The multi-purpose remote controller as claimed in claim 11, wherein the data line has a connector for being connected with a serial port of the personal computer at one end thereof, the data line having a connector for connecting the data line with the multi-purpose remote controller at the other end thereof.

13. The multi-purpose remote controller as claimed in claim 12, wherein the connector of the data line, set at one end thereof, is connected with the connection port and the connector of the data line, set at the other end thereof, is connected with a data input/output port of a mobile communication terminal.

14. The multi-purpose remote controller as claimed in claim 9, wherein the data memory is composed of an EEPROM (Electrically Erasable and Programmable ROM).

15. An apparatus for downloading control frequency code data, comprising:
a server in which control frequency code data for each of electronic equipment sets is loaded; and
a mobile communication terminal used as a multi-purpose remote controller, for downloading the control frequency code data for each electronic equipment set loaded in the server through the Internet and automatically setting it, to perform a remote control function corresponding to the control frequency code.

16. The apparatus as claimed in claim 15, wherein the mobile communication terminal used as a multi-purpose remote controller comprises:
a keypad including a plurality of function keys and a multi-purpose remote control mode key;
a transmission/reception separation unit for providing control frequency code data for each electronic equipment and general mobile communication data, received through an antenna, and for transmitting a remote control function signal provided thereto through the antenna;
a receiver for frequency-converting and demodulating the control frequency code data for each electronic equipment set, provided by the transmission/reception separation unit;
a controller for analyzing a signal outputted from the keypad to generate a predetermined control signal for automatically setting the control frequency code data for each electronic equipment, provided by the receiver, to perform a multi-purpose remote control function; and
a memory for storing the control frequency code data provided by the controller.

17. A mobile communication terminal used as a multi-purpose remote controller, comprising:
a keypad including a plurality of function keys and a multi-purpose remote control mode key;
a transmission/reception separation unit for providing control frequency code data for each electronic equipment and general mobile communication data, received through an antenna, and for transmitting a remote control function signal provided thereto through the antenna;
a receiver for frequency-converting and demodulating the control frequency code data for each electronic equipment set, provided by the transmission/reception separation unit;
a controller for analyzing a signal outputted from the keypad to generate a predetermined control signal for automatically setting the control frequency code data for each electronic equipment, provided by the receiver, to perform a multi-purpose remote control function; and
a memory for storing the control frequency code data provided by the controller.
